(19) United States
(12) Patent Application Publication
(10) Pub. No.: US 2004/0267573 A1
(43) Pub. Date: Dec. 30, 2004

(54) Device for collating, processing and visualizing clinical data

(75) Inventor: Massimo Federico, Modena (IT)

Correspondence Address: YOUNG & THOMPSON, 745 SOUTH 23RD STREET, 2ND FLOOR, ARLINGTON, VA, 22202, US

(73) Assignee: ASSOCIAZIONE ANGELA SERRA PER LA RICERCA SUL CANCRO, MODENA (IT)

(21) Appl. No.: 10/876,546

(22) Filed: Jun. 28, 2004

(30) Foreign Application Priority Data
Jun. 30, 2003 (IT) MO2003A000195

(51) Int. Cl. G06F 17/60

(52) U.S. Cl. 705/2

(57) ABSTRACT

A main memory contains a prefixed number of clinical parameters and means for visualizing, for displaying a main graphic representation of at least a human body. The device also comprises first means for selecting for choosing a prefixed portion of the representation, and second means for selecting for choosing, in the main memory, a predefined clinical parameter associated to the zone of a patient's body represented by the prefixed portion. The predefined clinical parameter is converted into a corresponding auxiliary graphic representation, which is displayed by the means for visualizing.

### BACKGROUND OF THE INVENTION

The invention relates to the field of collation, processing and visualization of data for clinical use; in more detail, the invention an be used in the oncological field for analysis of a state of illness in patients suffering from lymphoma or other tumors, where by the word “state”, the degree of progression of the tumor is intended, internally of the human organism.

As is known, the main data relating to the description of a tumor relate to the position and dimensions thereof. In other words, tables are usually compiled in which, for each patient, the position and the size of the afflicted tissue or organ is specified.

It is, however, obvious that these tables are neither simple nor immediate to consult, and that therefore an operator can only with difficulty reach a rapid and clear understanding of the patient's condition.

### SUMMARY OF THE INVENTION

The main aim of the present invention is to make available a device for collating, processing and visualizing the clinical data which overcomes the above-described drawbacks. In particular, the main aim of the present invention is to provide a device which collates, processes and visualizes the clinical data in such a way that the operator can precisely and immediately identify the patient's state of illness, with specific reference to the distribution of the illness within the organism. Another aim of the invention is to provide a device as above which is easily used by non-specialized operators, enabling them to interpret the memorized data correctly.

These aims and others besides are all attained by the device for collating, processing and visualizing clinical data, as it is described in the appended claims.

### BRIEF DESCRIPTION OF THE DRAWINGS

Further characteristics and advantages will better emerge from the description that follows, of a preferred but not exclusive embodiment of the device for collating, processing and visualizing clinical data, made with reference to the accompanying figures of the drawings, in which:

FIG. 1 is a block diagram of a device according to the present invention;

FIG. 2 is a schematic representation of an alternative embodiment of a functional block of the device of FIG. 1.

### DESCRIPTION OF THE PREFERRED EMBODIMENTS

The device for collating, processing and visualizing clinical data of the present invention is indicated in its entirety by number 1 in the figures.

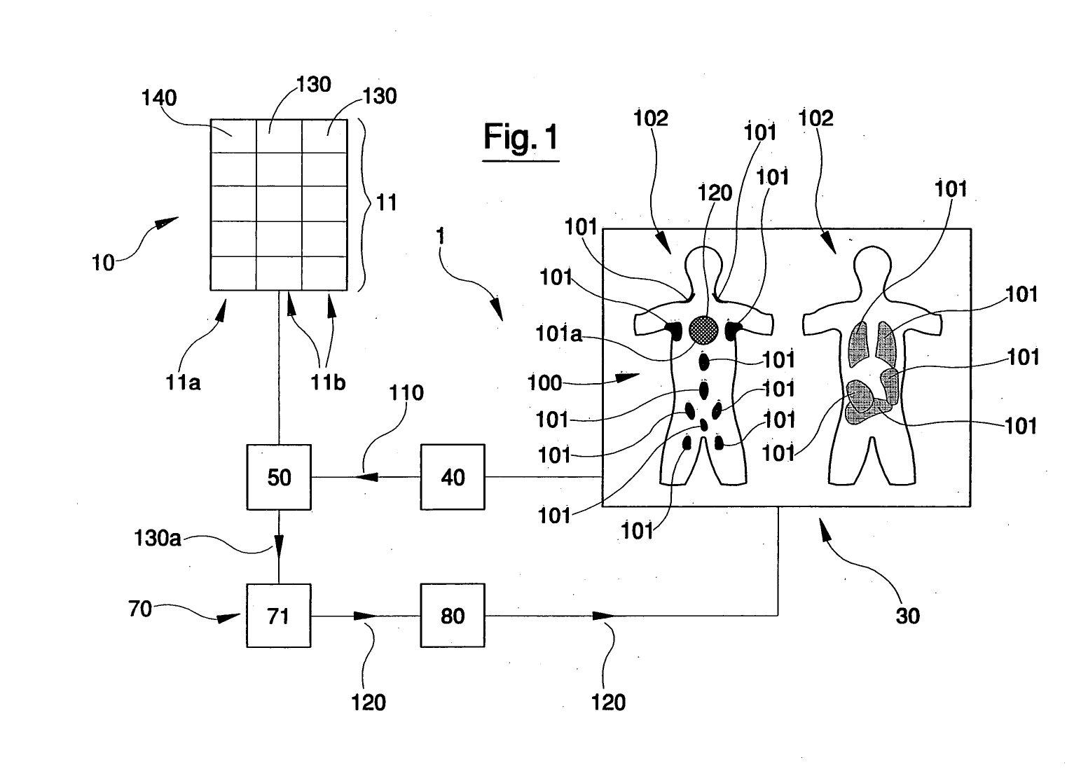

With reference in particular to FIG. 1, the device 1 comprises means for visualizing 30 for displaying a main graphic representation 100 of a human body.

The main graphic representation 100 is defined by a first representation 102 of a human body, in which preferably the positions of the main lymph-nodes are indicated, and by a second representation 103 of the human body, in which the extra-nodal organs (e.g. stomach, intestine, pancreas, etc) are represented. The main graphic representation 100 is subdivided into a predetermined number of portions 101, each representing a corresponding zone of the human body; in more detail, the first representation 102 is subdivided in such a way as to group together the lymph-nodes belonging to a same region, while the second representation 103 is subdivided to selectively identify the various extra-nodal organs of the human body.

As will be better described herein below, for each portion 101 it is possible to display an auxiliary graphic representation 120, which shows the condition of the portion 101 under examination.

For this purpose, the device 1 is provided with a main memory 10 for containing a prefixed number of clinical parameters 130; each of the clinical parameters 130 is representative of the conditions of a corresponding zone of the body of a patient.

In greater detail, the main memory 10 comprises a plurality of records 11, each associated to a respective patient.

Each record 11 exhibits a main field 11a, predisposed to contain an identifying code 140 of the patient associated to the record 11, and a predetermined number of auxiliary fields 11b, for containing the clinical parameters 130 relating to the conditions of the various parts of the patient's body.

The position and/or the size of a tumor may be included in the clinical parameters 130 of the patient.

Obviously the clinical parameters 130 can also relate to any other type of disturbance or pathology developed in one or more parts of the patient.

As will become clearer herein below, the auxiliary graphic representation 120 is indicative of the clinical parameters 130 memorized in the main memory 10. The device 1 is provided with first means for selection 40 for choosing a predetermined portion 101a (being a portion whose conditions are of particular interest) of the main graphic representation 100. The first means for selection 40 are in fact a conventional mouse and the driver associated thereto for correct functioning enables the user to identify the predetermined portion 101a which will then be displayed as the auxiliary graphic presentation 120.

In more detail, the first means for selecting 40, following a command received by the user, generate a main signal 110 which represents the predetermined portion 101a.

The device 1 further comprises second means for selecting 50, connected to the first means for selecting 40 and to the means for visualizing 30; the second means for selecting 50 receive the main signal 110a and then identify, in the main memory 10, at least one predefined clinical parameter 130a, associated to the zone of the patient's body represented by the prefixed portion 101a.

In other words, when a user selects a prefixed portion 101a, the second means for selecting 50 recognize, in the main memory 10, the predefined clinical parameter 130a representing the conditions of the identified portion.

Obviously, in a case where the conditions of the prefixed portion 101a have to be described by a plurality of parameters, all the predefined clinical parameters 130a will be memorized in the main memory 10 and will be collated according to the selection made by the user.

Further, where the main memory 10 contains data relating to a number of patients, a preliminary phase of patient selection will be performed, using the record 11 associated to the patient under examination.

Once the predefined clinical parameter 130a has been identified in the main memory 10, a conversion block 70 transforms the predefined clinical parameter 130a into an auxiliary graphic representation 120.

The conversion block 70 can be realized as a generator 71 of images, able to generate digital images according to the data received; in particular, in this case, according to the position, dimensions and, possibly, the state of growth of the tumor present in the prefixed zone 101a, the generator 71 provides in outlet a digital image having dimensions which are proportional to the real dimensions. This image is the auxiliary graphic representation 120 and is visualized by the means for visualizing 30 in the correct position.

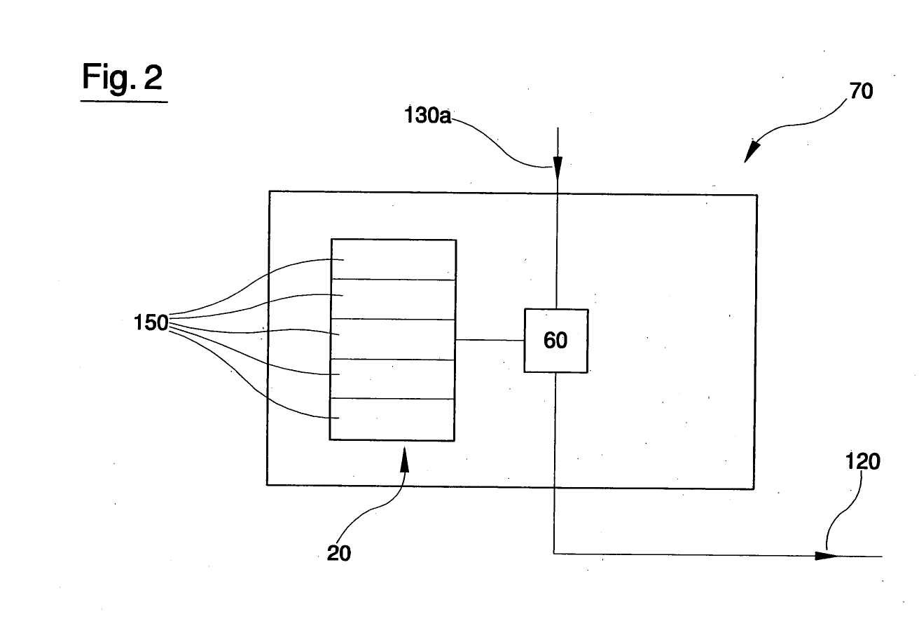

Alternatively, the conversion block 70 (FIG. 2) can be provided with an auxiliary memory 20 for memorizing a predefined number of images 150, each defining a corresponding auxiliary graphic representation 120; according to the predefined clinical parameter 130a identified by the second means for selection 50, third means for selecting 60 select at least one image 150 from the auxiliary memory 20.

The selected image 150 is then transmitted to the means for visualizing 30, in order to be displayed in combination with the main graphic representation 100. With the aim of sending the selected image 150 in the auxiliary memory 20 or the image provided by the generator 71 to the means for visualizing 30, the device 1 includes means for communicating 80, interpositioned between the conversion block 70 and the means for visualizing 30.

The invention offers important advantages.

Firstly, the device of the invention enables the user to view the conditions of the portion of interest of the patient's body, immediately and precisely.

Further, thanks to the advantageous graphic interface used, the displayed data can easily be understood by operators or users who are not particularly expert in the field, as well as by the patient him or herself during interviews with the specialized personnel.

What is claimed:

1). A device for collating, processing and visualizing clinical data, comprising:
a main memory, for containing a prefixed number of clinical parameters, each of which parameters represents conditions of a corresponding zone of a patient's body;
means for visualizing for displaying a main graphic representation of at least a human body, the main graphic representation being subdivided into a prefixed number of portions, each of which portions represents a corresponding zone of the at least a human body;
first means for selecting, associated to the means for visualizing, for selecting at least one prefixed portion of the main graphic representation and for generating a main signal, representative of the prefixed portion;
second means for selecting, connected to the first means for selecting, the means for visualizing and the main memory for receiving the main signal from the first means for selecting and for selecting, in the main memory, at least one predefined clinical parameter associated to the zone of the patient's body, being the prefixed portion;
a conversion block, associated to the second means for selecting for converting the at least one predefined clinical parameter into a corresponding auxiliary graphic representation;
means for communicating, interpositioned between the conversion block and the means for visualizing for transmitting the auxiliary graphic representation from the conversion block to the means for visualizing and for displaying the auxiliary graphic representation on the means for visualizing.

2). The device of claim 1, wherein the main memory comprises a plurality of records, each of which plurality of records is associated to a patient and contains:
a main field for containing an identification code of the patient;
a prefixed number of auxiliary fields for containing clinical parameters.

3). The device of claim 2, wherein the clinical parameters comprise a position or a dimension of a tumor of the patient, or both a position and a dimension of a tumor of the patient.

4). The device of claim 1, wherein the main graphic representation comprises a first representation of a human body, indicating a position of lymph nodes in the human body, and a second representation of the human body, indicating extra-nodal organs of the human body.

5). The device of claim 1, wherein the conversion block comprises a generator of images for generating the auxiliary graphic representation according to the at least one predefined clinical parameter.

6). The device of claim 1, wherein the conversion block comprises:
an auxiliary memory for memorizing a predefined number of images, each defining a corresponding auxiliary graphic representation;
third means for selecting, connected to the auxiliary memory and to the second means for selecting, for selecting, in the auxiliary memory, at least one of the predefined number of images, according to the predefined clinical parameter, and for transmitting the at least one of the predefined number of images to the means for visualizing.
